(19) United States
(12) Patent Application Publication
(10) Pub. No.: US 2022/0109136 A1
(43) Pub. Date: Apr. 7, 2022

(54) ELECTRODE ASSEMBLY AND METHOD OF MAKING THE SAME

(71) Applicant: GM Global Technology Operations LLC, Detroit, MI (US)

(72) Inventors: Nicole Ellison, Madison Heights, MI (US); Xiaosong Huang, Novi, MI (US); Mark W. Verbrugge, Troy, MI (US)

(21) Appl. No.: 17/060,606

(22) Filed: Oct. 1, 2020

(51) Int. Cl. H01M 4/04; H01M 4/62; H01M 4/66

(52) U.S. Cl. CPC H01M 4/0435; H01M 4/624; H01M 4/622; H01M 4/0471; H01M 4/663

(57) ABSTRACT

Disclosed herein is a method comprising disposing a slurry comprising an organic binder, an optional conductive filler, an optional solvent and an active material on a current collector; wherein the active material comprises a labile metal ion; removing the optional solvent to form a dry electrode; firing the dry electrode at a temperature of at least 200° C.; and carbonizing the organic binder to form a carbonized layer.

### BACKGROUND

This disclosure relates to the art of electrode assemblies, and more particularly, to cathode composition and formation.

Electrochemical cells can be used to power electronic devices, for example, computers, electric cars, and aviation components. Electrochemical cells include electrode assemblies, for example, an electrode assembly includes an anode (i.e., a negative electrode) and a cathode (i.e., a positive electrode). Binder materials, for example, polymers, are added to cathode compositions in order to increase the mechanical integrity of an electrode assembly, for example, increased robustness and adhesion between components within the cathode. Electrically conductive filler materials, for example, carbon black, single and multiwall carbon nanotubes, single and multilayer graphene, carbon fibers, metallic particles, graphite, and conductive polymers, are added to cathode compositions in order to increase the electrical conductivity of an electrode assembly.

However, inclusion of electrically conductive filler adds complexity to the composition of the cathode. Furthermore, inclusion of electrically conductive filler in a preliminary cathode material slurry mixture increases the viscosity of the mixture, thus making processing and formation of the final cathode product more difficult. For example, conductive filler materials can aggregate during processing, thus resulting in uneven charge and discharge cycles for the final electrochemical cell if said aggregations are not dispersed properly prior to final formation.

Accordingly, it is desirable to provide a cathode composition for an electrode assembly which allows for easy processing and formation while still maintaining both electrical conductivity and mechanical integrity.

### SUMMARY

In one embodiment, a method for manufacturing an electrode comprises disposing a slurry comprising an organic binder, an optional conductive filler, an optional solvent and an active material on a current collector. The active material comprises a labile metal ion. The optional solvent may be removed to form a dry electrode. The dry electrode is fired at a temperature of at least 200° C. The organic binder is then carbonized to form a carbonized layer on the current collector.

In another embodiment, the metal ion comprises a lithium ion.

In yet another embodiment, the organic binder comprises an organic polymer.

In yet another embodiment, the polymer comprises an ionomer that is neutralized with lithium ions.

In yet another embodiment, the method further comprises calendaring the slurry.

In yet another embodiment, the organic binder is present in an amount of 1 to 20 parts per hundred based on a total weight of the dry electrode and where the active material is present in an amount of 80 to 99 parts per hundred based on a total weight of the dry electrode.

In yet another embodiment, the carbonized layer has a thickness of greater than 50 micrometer.

In yet another embodiment, the firing includes simultaneously subjecting the dry electrode to convection currents as well as to radiation.

In yet another embodiment, the organic binder further segregates to produce a polymer-rich phase and a polymer-poor phase in the dry electrode, where the polymer-rich phase contains a higher percentage of polymer relative to another portion of the dry electrode and where the polymer-poor phase contains a lower percentage of polymer relative to another portion of the dry electrode.

In yet another embodiment, the polymer-rich phase is converted into a carbon-rich phase upon firing and where the polymer-poor phase is converted into a carbon-poor phase upon firing.

In yet another embodiment, a gradient in carbon content exists between the carbon-rich phase and the carbon-poor phase in the carbonized layer.

In yet another embodiment, the gradient is a linear or a curvilinear gradient.

In yet another embodiment, the gradient is a stepped gradient.

In yet another embodiment, the slurry has a viscosity of about 2 Pascal-seconds to about 10 Pascal-seconds at a shear rate of 20 reciprocal seconds and a temperature of 25° C. as measured in accordance with ASTM D2422-97(2018).

In yet another embodiment, the disposing of the slurry on the current collector, drying the slurry to form a dry electrode and the carbonization of the dry electrode are performed simultaneously.

In one embodiment, an electrode comprises a current collector and a carbonized layer; where the carbonized layer is disposed on a surface of the current collector. The carbonized layer comprises a porous carbonized binder network that encapsulates an active material particle. The active material particle comprises a labile metal ion.

In another embodiment, the metal ion is lithium.

In yet another embodiment, the carbonized layer has a porosity of 15 to 50 volume percent.

In yet another embodiment, the carbonized layer has a gradient in carbon concentration from a surface of the carbonized layer to an interface between the carbonized layer and the current collector.

In yet another embodiment, the carbonized layer has a thickness of at least 50 micrometers.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 depicts one exemplary method for manufacturing the electrode;

FIG. 2 depicts a graph that shows different carbon gradient profiles in the electrode;

FIG. 3 depicts another graph showing step gradient profiles that may be used in the electrode;

FIG. 4 is a schematic diagram depicting an exemplary process that may be used for manufacturing electrodes from a wet slurry; and

FIG. 5 is a schematic diagram depicting an exemplary process that may be used for manufacturing electrodes from a dry slurry.

### DETAILED DESCRIPTION

The following description is merely exemplary in nature and is not intended to limit the present disclosure, its application or uses.

Disclosed herein is a method for manufacturing thick electrodes for batteries that comprises a porous complex carbonized binder network (hereinafter a carbonized layer). The carbonized layer comprises a carbonized network that encapsulates an active material. The method comprises mixing an organic binder with an active material in an optional solvent to form a slurry. The slurry is applied to a surface of a current collector and optionally dried in a dryer to form the dry electrode. The dry electrode can be optionally calendared to achieve a porosity of 15 to 40 volume percent (vol %), preferably 18 to 25 vol %, based on a total volume of the dry electrode. The weight or volume of the dry electrode does not include the volume or weight of the current collector. The calendared dry electrode is then fired (annealed) at an elevated temperature to carbonize the organic binder and to convert it into an electrically conductive network.

The slurry referred to herein may be a wet slurry (a slurry that contains a liquid) or a dry slurry (a powder or a film). The wet slurry is dried to form a dry electrode prior to carbonization, while the dry slurry or film may be directly subjected to carbonization after being disposed on a current collector.

Carbonaceous materials as known in technical literature encompass both elemental carbon (EC) and organic carbon (OC). A carbonized material (which encompasses the carbonized binder network referred to herein) refers to carbon that cannot be vaporized upon heating. It does not encompass organic carbon except for trace amounts that may be originally present in the carbonaceous material. Organic carbon refers to carbon atoms that are covalently or ionically bonded to hydrocarbons with or without heteroatoms.

The FIGURE is an exemplary depiction of the method of converting the slurry 102 (that contains the active material) into a carbonized layer 202 (that contains the active material).

The slurry 102 coated on a current collector 110 comprises an organic binder 108, an active material 106 (that contains an ionic species, such as, for example a labile metal ion) an optional solvent and an optional conductive filler 104. The slurry 102 is first prepared by blending together the organic binder 108, the active material 106, the optional solvent (not shown) and the optional conductive filler 104. The slurry 102 is then dried to remove the optional solvent to form the dry electrode.

Upon being subjected to firing, the organic binder 108 undergoes carbonization to form the carbonized network 208 that encompasses and encapsulates or supports the active material 106. The carbonized network with the encapsulated active material is referred to as the carbonized layer 202. The carbonized layer 202 is porous to facilitate enhanced ionic conductivity and has a free surface 105 (a surface that contacts air when not disposed in a battery or in a capacitor) and an interfacial surface 103 that contacts the current collector 110.

The organic binder 108 is preferably a polymer. The polymer may be selected from a wide variety of thermoplastic polymers, blend of thermoplastic polymers, thermosetting polymers, or blends of thermoplastic polymers with thermosetting polymers. The organic polymer may also be a blend of polymers, copolymers, terpolymers, or combinations comprising at least one of the foregoing organic polymers. The organic polymer can also be an oligomer, a homopolymer, a copolymer, a block copolymer, an alternating block copolymer, a random polymer, a random copolymer, a random block copolymer, a graft copolymer, a star block copolymer, a dendrimer, a polyelectrolyte (polymers that have some repeat groups that contain electrolytes), a polyampholyte (a polyelectrolyte having both cationic and anionic repeat groups), an ionomer, or the like, or a combination comprising at last one of the foregoing organic polymers. The organic polymers have number average molecular weights greater than 10,000 grams per mole, preferably greater than 20,000 g/mole and more preferably greater than 50,000 g/mole and may have a molecular weight as high as 1,000,000 g/mole.

In an embodiment, the polymers may be synthetic or naturally occurring polymers.

Examples of synthetic thermoplastic polymers that can be used in the organic binder include polyacetals, polyacrylics, polycarbonates, polyalkyds, polystyrenes, polyolefins, polyesters, polyamides, polyaramides, polyamideimides, polyarylates, polyurethanes, epoxies, phenolics, silicones, polyarylsulfones, polyethersulfones, polyphenylene sulfides, polysulfones, polyimides, polyetherimides, polytetrafluoroethylenes, polyetherketones, polyether ether ketones, polyether ketone ketones, polybenzoxazoles, polyoxadiazoles, polybenzothiazinophenothiazines, polybenzothiazoles, polypyrazinoquinoxalines, polypyromellitimides, polyguinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, polypropylenes, polyethylenes, polyethylene terephthalates, polyvinylidene fluorides, polysiloxanes, or the like, or a combination thereof.

Copolymers that contain surface energy reducing moieties such as silicon containing moieties or fluorine containing moieties may also be used as binders. The repeat units that contain surface energy reducing moieties tend to migrate towards the surface and this technique can be used to manufacture a carbonized layer that has a carbon gradient from the surface of the current collector 103 to the free surface of the carbonized layer 105. This will be discussed in detail later.

Examples of polyelectrolytes are polystyrene sulfonic acid, polyacrylic acid, pectin, carrageenan, alginates, carboxymethylcellulose, polyvinylpyrrolidone, or the like, or a combination thereof.

Examples of synthetic thermosetting polymers suitable for use as the organic binder includes epoxy polymers, unsaturated polyester polymers, polyimide polymers, bismaleimide polymers, bismaleimide triazine polymers, cyanate ester polymers, vinyl polymers, benzoxazine polymers, benzocyclobutene polymers, acrylics, alkyds, phenol-formaldehyde polymers, novolacs, resoles, melamine-formaldehyde polymers, urea-formaldehyde polymers, hydroxymethylfurans, isocyanates, diallyl phthalate, triallyl cyanurate, triallyl isocyanurate, unsaturated polyesterimides, or the like, or a combination thereof.

In an embodiment, the organic binder can comprise a synthetic polymeric ionomer. The polymeric ionomer is preferably an ethylene containing ionomer also referred to as a polymeric ethylene ionomer. For example, the ethylene ionomer comprises an acrylic acid ethylene copolymer that is neutralized with a metal salt (e.g., by using a cation).

The acrylic acid ethylene copolymer is a polymer that can comprise repeat units in an amount of 5 to 50 wt %, preferably 10 to 20 wt %, and more preferably 12 to 15 wt %, by weight of a polar monomer such as acrylic acid, alkyl acrylic acid, or alkyl acrylate (additional examples are provided below), or combinations thereof, based on the total weight of the ethylene copolymer. The alkyl group may comprise 1 to 20 carbon atoms. The remainder of the copolymer is an ethylene polymer. Ethylene polymers including ethylene-α-olefin copolymers (defined above) may be used in the acrylic acid ethylene copolymer or in the ethylene ionomers (detailed below). The acrylic acid ethylene copolymer is either a random or block copolymer and is preferably a random copolymer.

Examples of such polar monomers include acrylic acid, methacrylic acid, ethacrylic acid, methyl acrylate, ethyl acrylate, methyl methacrylate, ethyl methacrylate, propyl acrylate, propyl methacrylate, isopropyl acrylate, isopropyl methacrylate, butyl acrylate, butyl methacrylate, isobutyl acrylate, isobutyl methacrylate, tert-butyl acrylate, tert-butyl methacrylate, octyl acrylate, octyl methacrylate, undecyl acrylate, undecyl methacrylate, octadecyl acrylate, octadecyl methacrylate, dodecyl acrylate, dodecyl methacrylate, 2-ethylhexyl acrylate, 2-ethylhexyl methacrylate, isobornyl acrylate, isobornyl methacrylate, lauryl acrylate, lauryl methacrylate, 2-hydroxyethyl acrylate, 2-hydroxyethyl methacrylate, glycidyl acrylate, glycidyl methacrylate, poly(ethylene glycol)acrylate, poly(ethylene glycol)methacrylate, poly(ethylene glycol) methyl ether acrylate, poly(ethylene glycol) methyl ether methacrylate, poly(ethylene glycol) behenyl ether acrylate, poly(ethylene glycol) behenyl ether methacrylate, poly(ethylene glycol) 4-nonylphenyl ether acrylate, poly(ethylene glycol) 4-nonylphenyl ether methacrylate, poly(ethylene glycol) phenyl ether acrylate, poly(ethylene glycol) phenyl ether methacrylate, dimethyl maleate, diethyl maleate, dibutyl maleate, dimethyl fumarate, diethyl fumarate, dibutyl fumarate, dimethyl fumarate, vinyl acetic acid, vinyl acetate, vinyl propionate, or combinations thereof.

The ethylene copolymer may comprise up to 35 wt % of an optional comonomer such as carbon monoxide, sulfur dioxide, acrylonitrile, maleic anhydride, maleic acid diesters, (meth)acrylic acid, maleic acid, maleic acid monoesters, itaconic acid, fumaric acid, fumaric acid monoester, a salt of these acids, glycidyl acrylate, glycidyl methacrylate, and glycidyl vinyl ether, or combinations thereof.

In an embodiment, the acid moiety of an ethylene copolymer is neutralized with a cation to produce the ionomer. The neutralization, for example, can be 0.1 to 100, preferably 10 to 90, preferably 20 to 80, and more preferably 20 to about 40 wt %, based on the total carboxylic acid content, with a metallic ion. The metallic ions can be monovalent, divalent, trivalent, multivalent, or combinations of two or more thereof. Examples include Li, Na, K, Ag, Hg, Cu, Be, Mg, Ca, Sr, Ba, Cd, Sn, Pb, Fe, Co, Zn, Ni, Al, Sc, Hf, Ti, Zr, Ce, or combinations thereof. A preferred ion is a lithium ion. An exemplary ionomer is SURLYN® commercially available from DuPont.

A preferred polymer for use in the organic binder is an ionomer. The ionomer is preferably neutralized with lithium ions.

Naturally occurring polymers are defined as materials that widely occur in nature or are extracted from plants or animals. Naturally occurring polymers include celluloses (e.g., hydroxyalkylcelluloses such as hydroxyethyl cellulose, hydroxymethylcellulose, hydroxypropylcellulose, or the like), naturally occurring rubber (e.g., polyisoprene), silk, wool, cotton, starch, gum, chitosan, alginic acid, or the like, or a combination thereof. Combinations of the foregoing polymers may be used as a binder in the slurry.

The organic binder is used in an amount of 0.5 to 20 parts per hundred (phr), preferably 2 to 18 phr and more preferably 3 to 10 phr, based on a total weight of the dry electrode.

The active material 106 is operative to provide ionic species to the electrode. In a preferred embodiment, the ionic species is a lithium ion. The active material 106 comprises lithium manganese oxide, lithium iron phosphate, lithium iron manganese phosphate, lithium nickel manganese cobalt oxide, lithium nickel cobalt aluminum oxide, lithium cobalt manganese aluminum oxide, lithium nickel aluminum manganese cobalt oxide, or the like, or a combination(s) thereof.

The active material is present in an amount of 80 to 99.5 phr, preferably 82 to 99 phr and more preferably 90 to 98 phr, based on the total weight of the dry electrode.

The slurry may also contain an optional solvent. Solvents are used to reduce the viscosity of the slurry and are also used to improve the dispersion and distribution of the active materials and fillers in the slurry. The solvent selected for the purpose is preferably a liquid that solvates the polymer.

In an embodiment, a cosolvent system may also be selected for facilitating dispersion and distribution of the active materials and fillers in the slurry. The cosolvent system may be selected such that one of the solvents is operative to solvate the polymer that is used as the organic binder, while the other solvent is immiscible with the same polymer. The immiscible solvent preferably has a higher boiling point than the miscible solvent. When the slurry is disposed on the current collector and subjected to an elevated temperature to dry the slurry, the miscible solvent evaporates gradually leaving behind the polymer in the immiscible solvent. During the gradual evaporation of the miscible solvent, the polymer redistributes unevenly in the slurry because of its incompatibility with the remainder of the slurry. The slurry will be polymer rich in some parts and polymer poor in some parts. In short there will be a gradient in polymer concentration in the slurry. As a result of the gradient in polymer concentration there will conversely be a gradient in the active material concentration in the dry electrode. The gradient in polymer concentration is inversely related to the gradient in active material concentrate in the dry electrode. In other words as the polymer concentration increases, the active material concentration decreases and vice-versa.

In summary, a gradient can also be created by drying the solvent at a predetermined rate. Solvent leaves the electrode top surface 105 during drying, which drives the organic binder to move to the top surface 105 as well. Conversely, the organic binder can settle to the current collector interface 110 which can be dictated by solvent evaporation rate.

In one embodiment, when choosing solvents for the electrode it is desirable to choose solvents that will promote the polymer to be either below its lower critical solution temperature or above its upper critical solution temperature as the solvent is being evaporated. Without being limited to theory, this facilitates phase separation of the polymer from the slurry (via spinodal decomposition and/or binodal decomposition) thereby creating the polymer gradient (which is later converted to a carbon gradient).

The solvents may be liquid aprotic polar solvents, polar protic solvents, non-polar solvents, or combinations thereof. Liquid aprotic polar solvents such as propylene carbonate, ethylene carbonate, butyrolactone, acetonitrile, benzonitrile, nitromethane, nitrobenzene, sulfolane, dimethylformamide, N-methylpyrrolidone, or the like, or combinations thereof are generally desirable for dissolving the organic binder. Polar protic solvents such as, water, methanol, acetonitrile, nitromethane, ethanol, propanol, isopropanol, butanol, or the like, or combinations thereof may be used. Other non-polar solvents such a benzene, toluene, methylene chloride, carbon tetrachloride, hexane, diethyl ether, tetrahydrofuran, or the like, or combinations thereof may also be used to dissolve the organic binder. Examples of preferred solvents are dimethylformamide, N-methylpyrrolidone, water, alcohols, tetrahydrofuran, acetone, or combinations thereof.

The solvent may be used in any desired amount depending upon the desired viscosity of the slurry. The solvent temperature and pressure may be varied in order to solvate the organic binder. The solvent may be used in amounts of 50 phr to 300 phr, preferably 100 to 250 phr.

As noted above, solvents may be used to create a polymer gradient in the slurry. When the slurry is subjected to firing (at elevated temperatures) to effect the carbonization of the polymer, the polymer gradient in the slurry will be converted to a carbon gradient in the carbonized layer 202.

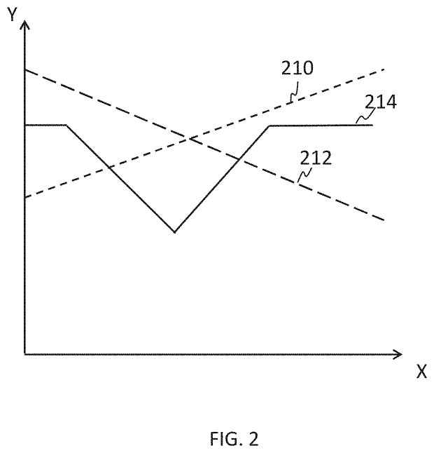

FIG. 2 is an exemplary graph showing possible carbon gradients in the electrode after carbonization. The X-axis represents electrode thickness as measured from the collector-electrode interface to the free surface of the electrode, while the Y-axis represents carbon concentration. Gradient A 210 shows increasing carbon concentration from the current collector-electrode interface to the free surface of the electrode, while Gradient B 212 shows decreasing carbon concentration from the current collector-electrode interface to the free surface of the electrode. While Gradient A 210 and B 212 are depicted as being linear gradients, they can be curvilinear too depending upon the phase separation characteristics of the polymer present in the dry electrode.

Gradient C 214 depicts a high carbon concentration at the electrode free surface as well as at the current collector-electrode interface, while the carbon concentration is lowered in regions between the free surface and the interface.

Some surfaces of the carbonized layer will be carbon-rich while other surfaces of the carbonized layer will be carbon-poor. Conversely, some surfaces of the carbonized layer will be active material-rich, while other surfaces of the carbonized layer will be active material-poor.

A polymer gradient can also be created by using copolymers where one polymer comprises a surface energy reducing moiety. Surface energy reducing moieties preferably contain a silicon atom or a fluorine atom. The polymer (of the copolymer) with the silicon atom or the fluorine atom tends to migrate towards the free surface (the slurry surface that contacts air) of the slurry and forms a separate phase that is rich in the energy reducing moiety. Drying and firing of the slurry (after depositing it on a current collector) will leave behind a carbon-rich phase (with some silicon or fluorine) at the free surface of the carbonized layer 202 and a carbon-poor phase at the surface of the electrode that contacts the current collector.

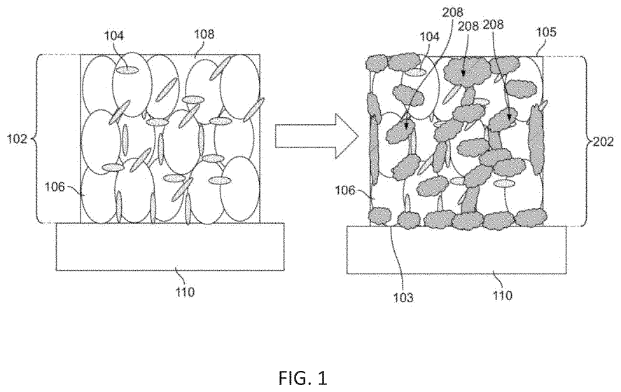

For example if a copolymer of a fluorocarbon polymer and an acrylic polymer is used as the organic binder (in the slurry), the fluorocarbon polymer will phase separate and segregate towards the free surface 105 (See FIG. 1) of the electrode while the content of the fluorocarbon polymer at the interface 103 is significantly less than that at the free surface. The acrylic polymer will concentrate at the interface 103 with a lower concentration at the free surface 105. Firing of the electrode will result in a carbon-rich phase at the surface 105 and a carbon-poor surface at the surface 103 of the electrode.

The gradients thus created may be uniformly linear or curvilinear gradients with the carbon-rich phase existing at the free surface of the carbonized layer or at the interface with the current collector. The opposing surface of the electrode will therefore be carbon-poor.

In an embodiment, the carbon-rich phase may exist at the free surface of the carbonized layer as well as at the interface while the central portion of the carbonized layer (between the free surface and the interface) will be carbon-poor.

Gradients having a step function in carbon content from the free surface 105 to the interface 103 may also be produced. In this embodiment, the slurry may be added to the current collector in several layers, with each layer having a different binder concentration from the preceding layer. A new layer is added to the current collector only after the previous layer has dried sufficiently. When several layers of slurry have been added to create a plurality of slurry layers, the current collector is subjected to firing to carbonize the organic binder. Because each slurry layer contained a different amount of binder, the carbonized layer will have a plurality of layers with different amounts of carbon. A layer which contains a larger amount of binder will be converted to a carbon-rich layer, while a layer that contained smaller amounts of binder will be converted to a carbon-poor layer relative to the carbon-rich layer. This method can be used to produce gradients of all kinds (e.g., step-wise gradients, saw tooth gradients, square block gradients, and the like).

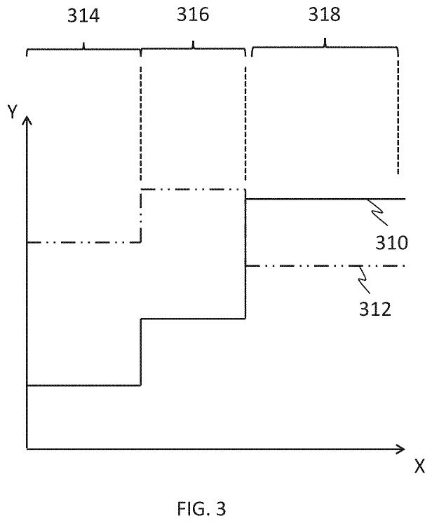

This method of producing carbon gradients in the electrode results in discontinuous carbon concentrations where the carbon concentration can vary discontinuously with distance from the electrode. FIG. 3 depicts at least two such gradient profiles—Gradient D 310 (see profile with solid line) and Gradient E 312 (see profile with dot and dash line), both of which are step profiles. Once again, the X-axis represents electrode thickness as measured from the collector-electrode interface to the free surface of the electrode, while the Y-axis represents carbon concentration. Three layers (Layer 1 314, Layer 2 316 and Layer 3 318) having different polymer concentrations and different thicknesses were disposed on the current collector to produce each gradient. Layer 3 318 has a greater thickness than Layer 1 314, which has a greater thickness than Layer 2 316. For Gradient D 310, the polymer concentration is lowest at the interface (Layer 1 314) and greatest at the free surface (Layer 3 318), with Layer 2 316 having a polymer concentration that lies between that of Layer 1 314 and Layer 3 318. Upon carbonization, Layer 1 314 has the lowest carbon concentration, while Layer 3 318 has the highest carbon concentration for the Gradient D 310.

Gradient E 312 was produced by using 3 layers of the same thickness as in Gradient D 310. However, for this gradient, the amount of polymer used in Layer 2 316 was greater than that used in Layer 1 314, which in turn was greater than that used in Layer 3 318. Upon carbonizing the multilayer electrode, the carbon concentration in Layer 2 316 can be seen to be greater than the carbon concentration in Layer 3 318, with the carbon concentration in Layer 1 314 lying between that of Layer 2 316 and Layer 3 318. Thus, by initially manufacturing different layers with different polymer concentrations relative to the concentration of the active material, a variety of different carbon concentration profiles may be achieved in the electrode.

In manufacturing an electrode having multiple layers with different initial polymer concentrations, the multilayer electrode may first be produced by coextrusion. The coextruded polymer layers are bonded together in a roll mill and then bound to the current collector, prior to being carbonized. Multilayer electrodes having 2 to 15 carbonized layers (of different carbon concentrations) may thus be produced.

The slurry may also contain optional fillers. The fillers may be electrically conducting fillers. Examples of electrically conducting fillers are carbon black, graphite, carbon nanotubes (single wall carbon nanotubes, multiwall carbon nanotubes, double wall carbon nanotubes), carbon fibers (derived from pitch, PAN, or the like), ceramic fillers (indium tin oxide, antimony oxide, and the like) or metallic fillers (copper, nickel, brass, iron, and the like). The ceramic fillers and the metallic fillers may be in the form of particles (having an aspect ratio of around 1), or fibers (having an aspect ratio of greater than 2, preferably greater than 5 and more preferably greater than 10), Higher aspect ratio fillers can be used to provide mechanical integrity to the carbonized layer (and hence to the electrode) at lower weight percentages than other particulate fillers that have aspect ratios of 2 or less.

The filler increases the viscosity of the slurry. It is therefore desirable to select the amount and type of filler based on the viscosity of the slurry and the mechanical integrity of the carbonized layer. In an embodiment, a dynamic viscosity of the slurry prior to drying, can be about 2 Pascal-seconds to about 10 Pascal-seconds at a shear rate of 20 reciprocal seconds and a temperature of 25° C. as measured in accordance with any suitable viscosity measuring standard, for example, ASTM D2422-97(2018).

Fillers are generally incorporated in amounts of up to 15 parts per hundred, preferably up to 10 parts per hundred and more preferably up to 2 parts per hundred based on the total weight of the dry electrode.

In an embodiment, in one method of manufacturing the electrode, the organic binder, active material, optional solvent and optional filler are blended together to form a slurry. The slurry may be a wet slurry or a dry slurry (in the form of a powder). The slurry is deposited on to a surface of a current collector in the form of a layer (up to a desired thickness). The current collector is preferably a metal or ceramic sheet that is electrically conducting. Suitable current collectors include copper, aluminum, nickel, titanium, glassy or carbon clothes, and/or stainless steels. Ceramic sheets may include indium tin oxide, tin oxide, antimony tin oxide, antimony oxide, or the like, or a combination thereof.

The slurry has a thickness of 200 micrometers or greater, preferably 250 micrometers or greater, and more preferably 300 micrometers or greater. The slurry upon being dried, optionally calendared and carbonized shrinks to form a carbonized layer than is thinner than the original slurry layer.

The collector together with the dry electrode disposed thereon is then fired in a furnace to a temperature of greater than 200° C., preferably greater than 300° C., preferably greater than 600° C. and more preferably to a temperature of greater than 800° C. until all of the organic binder undergoes carbonization. The time period for carbonization of the slurry is dependent upon the slurry thickness and the source of heat and is 2 minutes to 6 hours, preferably 5 minutes to 5 hours, and more preferably 10 minutes to 1 hour. The current collector with the carbonized layer disposed thereon may then be used as an electrode in a battery. The electrode may be an anode or a cathode depending upon the utility of the battery. In an embodiment, the electrode is preferably a cathode.

The carbonized layer has a porosity of 10 to 50 volume percent, preferably 15 to 40 volume percent and more preferably 17 to 25 volume percent, based on the total volume of the carbonized layer. The porosity is measured by any suitable method for measuring apparent porosity, for example, ASTM C1039-85(2015).

The electrode disclosed herein may be produced in a batch process or in a continuous process. In a batch process, a section of the current collector with the slurry disposed on it is fired in a furnace to carbonize the organic binder thereby producing the electrode.

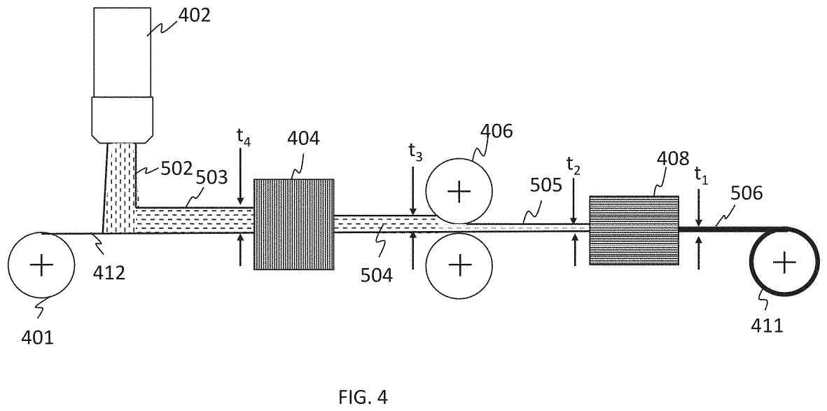

FIG. 4 depicts one exemplary embodiment of a continuous process that may be used to manufacture electrodes starting from a wet slurry (a slurry that contains a solvent) or a dry slurry (a powder that contains little or no liquid).

In the continuous process depicted in the FIG. 4, a continuous sheet (of the current collector) 412 may be unwound from a first spool 401 and wound onto a second spool 411 after having disposed on it the carbonized electrode 506. A wet or dry slurry 502 is continuously deposited from a mixing device 402 onto the continuous sheet 412 during its travel from the first spool 401 to the second spool 411. Wet slurries contain a solvent, while dry slurries (preferably containing little or no solvent) are in powder form prior to deposition on the current collector.

The continuous sheet 412 with the slurry 503 disposed thereon (having a thickness t₄) is fed into a first furnace 404 (set to a desired temperature) to dry the slurry (to remove any solvent or undesirable volatiles). The dry slurry 504 emerging from the first furnace 404 has a thickness t₃, which is less than thickness t₄. Following this it is calendared in a roll mill 406 to a desired thickness t₂ to form the dry electrode 505. The calendaring densities the material (reducing its porosity to a desired value) and provides better contact between the dry electrode and the current collector. The densification of the dry electrode via calendaring improves the energy density of the resulting electrode after carbonization.

The calendaring may be conducted cold (from room temperature to about 120° C. to facilitate a removal of the solvent and volatiles) or hot (at 100° C. or greater to 300° C.) to facilitate a melting of the polymer so that it can encapsulate the active material and bond to it. Hot calendaring is conducted when the slurry is dry (contains no solvent and is in the form of a powder) prior to deposition on the current collector.

Following calendaring, the polymeric binder is carbonized in a second furnace 408. The second furnace 408 is located downstream of the first spool 401 and upstream of the second spool 411. It is located downstream of the first furnace 404 and the roll mill (that performs the calendaring) 406. The carbonized layer has a thickness t₁, which is less than t₄, t₃ or t₂. From the FIG. 4, it may be seen that t₄>t₃>t₂>t₁. In other words, with each processing step, the thickness of the layer disposed on the current collector is reduced. The sheet 412 with the carbonized layer 506 disposed thereon may then be wound on spool 411 and stored for further use.

In the process displayed in the FIG. 4, the disposing of the slurry on the current collector, drying of the slurry and the carbonization of the electrode are performed simultaneously on the same current collector. The furnace 408 used for carbonization may be a convection oven, a radiation chamber, or a convection oven where the sample is also subjected to an appropriate form of radiation. Suitable forms of radiation are microwave radiation, radiofrequency radiation, infrared radiation, ultraviolet radiation, or the like, or a combination thereof. Preferred forms of radiation are microwave or radiofrequency radiation.

In an embodiment, the furnace 408 is a travelling wave guide where the slurry (disposed on the continuous sheet) is simultaneously subjected to microwave radiation as well as to convection currents. The atmosphere used during the carbonization is preferably an inert atmosphere such as carbon dioxide, argon, nitrogen. Carbon dioxide is preferred. In an embodiment, a vacuum may also be used during the carbonization process.

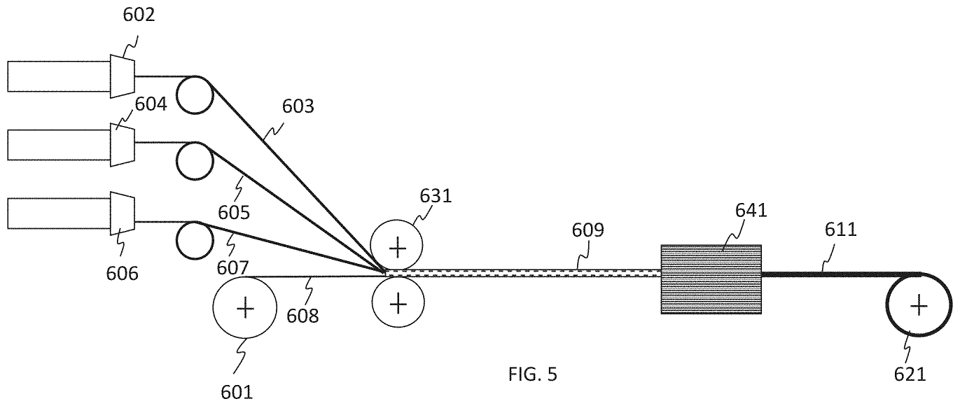

FIG. 5 depicts another embodiment of an exemplary process that may be used for carbonizing dry slurries that are disposed upon a current collector. In the FIG. 5, one or more films containing the active material and a polymeric binder are simultaneously coextruded from different extruders and are calendared onto the current collector. Following the calendaring process, the dry electrode is carbonized in a furnace and then wound onto a spool for further use.

With reference to the FIG. 5, a first dry slurry in the form of first film 603, a second dry slurry in the form of second film 605 and a third dry slurry in the form of third film 607 are coextruded from extruders 602, 604 and 606 respectively. Simultaneously a continuous sheet (of the current collector) 608 may be unwound from a first spool 601 and wound onto a second spool 621 after having disposed on it the carbonized electrode 611. The first film 603, second film 605, third film 607 and continuous sheet 608 are calendared in a roll mill 631 to reduce the thickness of the three films and to bond them to the continuous sheet 608. The calendaring used herein is preferably hot calendaring in order to facilitate a melting of the polymeric binder and a dispersion of the active material in the organic binder. The dry electrode thus formed is then subjected to carbonization in the furnace 641 to form electrode 611, which is then wound around the second spool 621.

The methods disclosed herein are advantageous because they can be used to manufacture electrodes having a thick carbonized layer. The carbonized layer may have a thickness of greater than 50 micrometers, preferably greater than 100 micrometers, and more preferably greater than 150 micrometers. Depending upon the organic binder used, the carbonized layer may also contain additional lithium ions, which will improve current discharge performance of the battery.

The electrodes manufactured by the aforementioned method may be used in batteries, capacitors, current storage devices, and the like.

While the invention has been described with reference to some embodiments, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiments disclosed as the best mode contemplated for carrying out this invention, but that the invention will include all embodiments falling within the scope of the appended claims.

What is claimed is:

1. A method comprising:
disposing a slurry comprising an organic binder, an optional conductive filler, an optional solvent and an active material on a current collector; wherein the active material comprises a labile metal ion;
removing the optional solvent to form a dry electrode;
firing the dry electrode at a temperature of at least 200° C.; and
carbonizing the organic binder to form a carbonized layer on the current collector.

2. The method of claim 1, where the metal ion comprises a lithium ion.

3. The method of claim 1, where the organic binder comprises an organic polymer.

4. The method of claim 3, where the polymer comprises an ionomer that is neutralized with lithium ions.

5. The method of claim 1, further comprising calendaring the slurry.

6. The method of claim 1, where the organic binder is present in an amount of 1 to 20 parts per hundred based on a total weight of the dry electrode and where the active material is present in an amount of 80 to 99 parts per hundred based on a total weight of the dry electrode.

7. The method of claim 1, where the carbonized layer has a thickness of greater than 50 micrometer.

8. The method of claim 1, where the firing includes simultaneously subjecting the dry electrode to convection currents as well as to radiation.

9. The method of claim 1, wherein the organic binder further segregates to produce a polymer-rich phase and a polymer-poor phase in the dry electrode, where the polymer-rich phase contains a higher percentage of polymer relative to another portion of the dry electrode and where the polymer-poor phase contains a lower percentage of polymer relative to another portion of the dry electrode.

10. The method of claim 9, where the polymer-rich phase is converted into a carbon-rich phase upon firing and where the polymer-poor phase is converted into a carbon-poor phase upon firing.

11. The method of claim 10, where a gradient in carbon content exists between the carbon-rich phase and the carbon-poor phase in the carbonized layer.

12. The method of claim 11, where the gradient is a linear or a curvilinear gradient.

13. The method of claim 12, where the gradient is a stepped gradient.

14. The method of claim 1, wherein the slurry has a viscosity of about 2 Pascal-seconds to about 10 Pascal-seconds at a shear rate of 20 reciprocal seconds and a temperature of 25° C. as measured in accordance with ASTM D2422-97(2018).

15. The method of claim 1, wherein the disposing of the slurry on the current collector, drying the slurry to form a dry electrode and the carbonization of the dry electrode are performed simultaneously.

16. An electrode comprising:
a current collector; and
a carbonized layer disposed on a surface of the current collector; where the carbonized layer comprises a porous carbonized binder network that encapsulates an active material particle; where the active material particle comprises a labile metal ion.

17. The electrode of claim 1, where the metal ion is lithium.

18. The electrode of claim 1, where the carbonized layer has a porosity of 15 to 50 volume percent.

19. The electrode of claim 1, where the carbonized layer has a gradient in carbon concentration from a surface of the carbonized layer to an interface between the carbonized layer and the current collector.

20. The electrode of claim 1, where the carbonized layer has a thickness of at least 50 micrometers.
